(19) United States
(12) Patent Application Publication
(10) Pub. No.: US 2003/0126001 A1
(43) Pub. Date: Jul. 3, 2003

(54) Process for managing requests for work within an organization through a centralized workflow management system

(76) Inventors: Margo Northcutt, Richmond, VA (US); Wanda MacGregor, Phoenix, VA (US); Travis Andrew Morell, Donalds, SC (US); Laurie Bockorick, Louisville, KY (US); Joy Taylor, Richmond, VA (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/028,283

(22) Filed: Dec. 28, 2001

(51) Int. Cl. G06F 17/60

(52) U.S. Cl. 705/8

(57) ABSTRACT

A system and method for managing the workflow of request for services from a department within an organization, the requests for service being provided by other members of the organization. A request for service input module enables one or more requesting members of the organization to input information for a request for service from the department by connecting to the system over a network (e.g., an intranet). A database system stores information regarding the requests for service received by the request for service input module. A change of status input module enables a service provider participant from the department to update the status of a request by connecting to the system over a network. A signoff module enables a service provider participant and a requesting member to signoff a requested service, the participant and requesting member connecting to the system over a network.

### FIELD OF THE INVENTION

The present invention relates to a process for managing requests for work through a centralized workflow management system. More specifically, the present invention relates to a process for receiving requests for work (e.g., information technology requests) recording the requests, updating the status of work saved in the management system, automatically notifying affected users regarding the status and changes, and enabling reports and prioritization based on the stored and in-progress requests.

### BACKGROUND OF THE INVENTION

Good resource management is an important factor contributing to the success of an information technology services department. In large business organizations, numerous different business units may make requests for information technology services. Traditionally, information technology departments have attempted to manage workflow through the use of paper processes, telephone communications, personal meetings, and other traditional business methodologies. In large organizations, management of the information technology tasks to be performed, their status, and updating all of the affected individuals can overtake the actual work to be done.

Accordingly, entire management staffs have traditionally been created to manage the information technology work being performed by a company. Further, to generate reports and status information, managers must collect forums, communicate with information technology personnel, and constantly attempt to obtain the information necessary to generate up-to-date and relevant reports.

These and other deficiencies and drawbacks exist with current business practices and methodologies and systems.

### SUMMARY OF THE INVENTION

Accordingly, the present invention overcomes these drawbacks and deficiencies by providing a centralized workflow management system for managing requests for information technology services. While the present invention will be described with reference to requests for service in the information technology area, it should be appreciated that this invention may also be applied to other services provided within a large corporate organization or any other type of organization.

The present invention provides a system and methodology whereby members of an organization may submit requests for service to a centralized workflow management system. The system may record requests, status changes, and other information into one or more database systems. Members interested in a particular request may be notified of changes, updated with status information, and be linked to records displaying information about the request stored in the database system. Additionally, reports may be generated that enable users to sort in multiple ways, including use of application programs that enable detailed analysis of the status of one or more ongoing information technology services. Members may use the system to prioritize or weight requests ongoing by the department or use an automated prioritization scheme for doing so.

The work management system operates based on a request for service (RFS). An RFS is a process that enables an authorized user to make a request of the information technology services department of an organization to perform certain information technology tasks. It should be appreciated that an authorized user may be any member of affiliate of an organization with rights to have services provided by this particular information technology department. As discussed above, if this invention is applied to other services, the authorized users will be those users authorized to receive services from that department.

One example of a type of request may be a request by the information technology department to make an update to an existing application in the organization or designing and developing a new information technology solution for the business. The centralized workflow management system serves as the central repository for all such RFSs to enable a work management department of the organization to control and understand the activities of that department. Additional classification of members of the organization may also have access to the centralized workflow management system, including requestors, strategists, developers, projects leaders, and many others for whom access to the information is desired.

In addition, the work management system provides the following functionality to enable better control over the services provided by a department: access work management process documents; supply feedback via email or other communications to work management personnel; track time by department personnel on various projects; enable remote and web-based access for submitting requests for services; view existing requests for services; sign off on requests for services that have been completed; and create many different types of reports. The centralized workflow management system provides module to enable users to submit a request, including filling in an appropriate field within a web-based interface, view summaries of requests submitted, add a quick hit of quick response items from the information technology services department, add a cost benefit analysis request to a feasibility request, edit existing RFSs, add comments to existing RFSs, change the status or IT responsibility person of a request, sign off on completed RFSs, and generate reports including prespecified requests to reports, general reports, and customized “create your own” reports.

Accordingly, one embodiment of the present invention relates to a system for managing the workflow of request for services from a department within an organization, the request for services being provided by other members of the organization. The system comprises a request for service input module for enabling one or more requesting members of the organization to input information for a request for service from the department by connecting to the system over a network (e.g., an intranet), a database system for storing information regarding the requests for service received by the request for service input module, a change of status input module for enabling a service provider participant from the department to update the status of a request by connecting to the system over a network, and a signoff module to enable a service provider participant and a requesting member to signoff a requested service, the participant and requesting member connecting to the system over a network.

The system may provide modules to enable users to change pending requests, input cost benefit analysis information related to the request for service, request reports regarding requests for service stored in the database, and enter time regarding requests for service being processed by service providers. The system may further provide an electronic messaging module that generates a message regarding a request. The messaging module may transmit a link to the stored request for service in various messages, including a message regarding the receipt of a new request for service received by the request for service input module to a service provider department member, a message regarding the receipt of a change to a request for service to the member that requested the service, a message regarding availability of a service for user testing to the requester of the service and a message regarding the availability of a service for warranty review by the requestor of the service.

According to another embodiment of the present invention, a method may be provided for managing the workflow of request for services from a department within an organization, the request for services being provided by other members of the organization. This method may comprise the steps of enabling one or more requesting members of the organization to input information for a request for service from the department by connecting through a networked interface system, storing information regarding the requests for service received, electronically forwarding information regarding the received request for service to a service provider participant, enabling a service provider participant to signoff a requested service based on performance of one or more tasks in the requested service, and enabling a requestor to signoff a requested service.

Additional embodiments of the present invention may involve the step of assigning a received service to one or more service provider participants, enabling a service provider participant to change the status of a request for service through the networked system, presenting a requestor with an interface through which the user may input cost benefit analysis information related to the request for service, and presenting a user with a reporting interface through which the user may request one or more reports regarding requests for service stored in the database. The method may also involve the transmission of electronic messages based on new requests for services, changes to the request for service and the like.

A technical advantage of the present invention is provided by the centralized workflow management system and database for storing and managing all information technology service requests for an organization and automatically alerts participants of changes and completion of the requests.

It is to be understood that the foregoing general description of the invention and the following detailed description are exemplary and explanatory only and are not to be restrictive of the invention as claimed.

### BRIEF DESCRIPTION OF THE DRAWINGS

FIG. 1 depicts a schematic representation of the flow of information in a centralized workflow management system according to one embodiment of the present invention.

FIG. 2 depicts a schematic diagram of a processes of a workflow management system according to one embodiment of the present invention.

FIG. 3 depicts an overall flow diagram of a request for service process according to one embodiment of the present invention.

FIGS. 4A-4B depicts a process for submission of a request for services according to one embodiment of the present invention.

FIG. 5 depicts a process for a request for a quick hit according to one embodiment of the present invention.

FIG. 6 depicts a flow diagram of a process for adding a cost benefit analysis as part of a feasibility request according to an embodiment of the present invention.

FIG. 7 depicts a flow diagram for viewing an existing request for service according to an embodiment of the present invention.

FIG. 8 depicts a flow diagram of a process for editing an existing request for service according to an embodiment of the present invention.

FIG. 9 depicts a flow diagram of a process for addition comments to an existing request for service according to an embodiment of the present invention.

FIG. 10 depicts a flow diagram of a process for changing a request for service status or IT responsibility according to one embodiment of the present invention.

FIG. 11 depicts a flow diagram for a process for signing off on a request for service according to one embodiment of the present invention.

FIG. 12 depicts an example request for service form for use with an application program for inputting a request for service according to an embodiment of the present invention.

FIGS. 13A-13B depict a based system for submitting a request for service according to an embodiment of the present invention.

FIG. 14 depicts an interface for viewing a request for service summary according to an embodiment of the present invention.

FIG. 15 depicts an interface for adding a quick hit according to an embodiment of the present invention.

FIG. 16 depicts an interface for adding a cost benefit analysis to a feasibility request according to one embodiment of the present invention

FIG. 17 depicts an interface for viewing an existing request for service according to an embodiment of the present invention.

FIG. 18 depicts an interface for editing existing requests for service according to an embodiment of the present invention.

FIG. 19 depicts an interface for adding comments to an existing request for service according to an embodiment of the present invention.

FIG. 20 depicts an interface for changing the status or IT responsibility of a request for service according to an embodiment of the present invention.

FIG. 21 depicts an interface for initial input of information to sign off on a request for service according to an embodiment of the present invention.

FIGS. 22A-22B depict interfaces for completing a sign off on a request for service according to an embodiment of the present invention.

FIG. 23 depicts an interface for requesting reports from a work management system according to an embodiment of the present invention.

FIG. 24 depicts a table representing exemplary fields of information available for output in one or more reports according to an embodiment of the present invention.

FIG. 25 depicts an interface for enabling a user to create a customized report from a workflow management system according to an embodiment of the present invention.

FIG. 26 depicts an interface for enabling a use to create his own report according to an embodiment of the present invention.

FIG. 27 depicts an overall architectural diagram for managing workflow in a system according to an embodiment of the present invention.

### DETAILED DESCRIPTION OF THE INVENTION

Reference will now be made in detail to exemplary embodiments of the invention, examples of which are illustrated in the accompanying drawing in which like reference characters refer to corresponding elements. One skilled in the art, given the description of the invention herein, will recognize the utility of the system and process of the present invention and a variety of diverse business environments in which processing of work flow in an efficient and automated manner is desirable. For example, the system and process of the present invention may be adapted for use in work flow management related to information technology service requests, as well as in other functional areas of a large business organization. However, for ease of description, the present invention will be described in the context of an information technology services environment.

Although an information technology service may handle many different types of requests, for purposes of explanation, in one embodiment, the services may be categorized into four types: feasibility request, project request, service request, and a quick hit request.

A feasibility request may be understood as a request to determine if a solution is worth pursuing and whether the proposed solution is technologically realistic, given the current IT environment. At this point a project or service request have not been provided and the organization desires to determine whether to do so. In general, an initiation review is performed (if the goal is to eventually develop a project request type) to ensure that a detailed plan, cost/benefit analysis, and budget and controls for project execution have been developed. If the request is to become a service request type, a smaller scale initiation phase may be done.

In the RFS process (as outlined below), the requestor submits the feasibility request and when the feasibility and initiation phases are complete, the requestor submits the benefits information. The feasibility request may then become a project request (e.g., 160 IT hours or more) or a Service Request (e.g., less than 160 IT hours). If the feasibility study is lead by a strategist, the IT Responsibility may then be changed to a project manager on a development or service team. After accepting the request, the project manager assigned at this point enters the cost estimate. Appropriate status codes for feasibility requests are: RC-received, not yet started; as-assigned, applies to the feasibility through design phases; HD-on hold, work may have started, but has halted for various reasons (put reason in comments field on RFS form); appropriate for feasibility requests when put on hold during feasibility/initiation phase, but not during design, build, test or warranty phases; CN-cancelled (user has decided the request is no longer needed). Appropriate request categories may include development, enhancement, mandatory maintenance, platform consolidation.

A project request may be understood to be a request that is estimated to take more than a predetermined number of IT hours (e.g., 160 hours). A cost benefit analysis is generally ready and prioritization of this request is provided by the system's automatic prioritization scheme. Appropriate status codes may include: Received—work is received in it and application enters status; Assigned—work has been assigned and application changes status from received to assigned when it responsibility accepts request; Active—build phase has begun and it responsibility changes status to active; work/coding begins; Pending Model Installation—optional, it responsibility may change status after work has been unit tested and is ready to move to model office; User Test—formal acceptance testing has begun; Pending Production Implementation—User Signoff Obtained and Application changes status after Signoff is submitted; Warranty Period—Change Management changes status when code is moved to Production; Completed—RFS has been completed, application changes and no further tasks submitted under this RFS number; Cancelled—RFS has been cancelled and status changed by IT responsibility; and On Hold—RFS is temporarily on hold and status changed by it responsibility. Appropriate request categories would include development, enhancement, mandatory maintenance, and platform consolidation.

A service request may be understood to be a request that is estimated to take less than a predetermined amount of IT hours (e.g., 160 hours) to complete. A cost benefits analysis has been done and prioritization is to be done. Applicable appropriate status codes are the same as for project requests. Appropriate request categories would include development, enhancement, minor change, software error, ad hoc reporting, mandatory maintenance, platform consolidation, and table change.

A quick hit request may be understood to be a service with a short turnaround time involves. Examples include production down (software fixes required) (whatever amount of time it takes to get production up again), software error with no workaround (e.g., <9 hours), table changes (e.g., <4 hours), state changes (approvals & exceptions) (e.g., <4 hours), minor changes to existing software (e.g., <7 hours), and e-quick hits (e.g., <5 days).

Appropriate status codes may be the same as for a service request. Appropriate request categories may include minor change, software error, ad hoc reporting, mandatory maintenance, table change, and incident report.

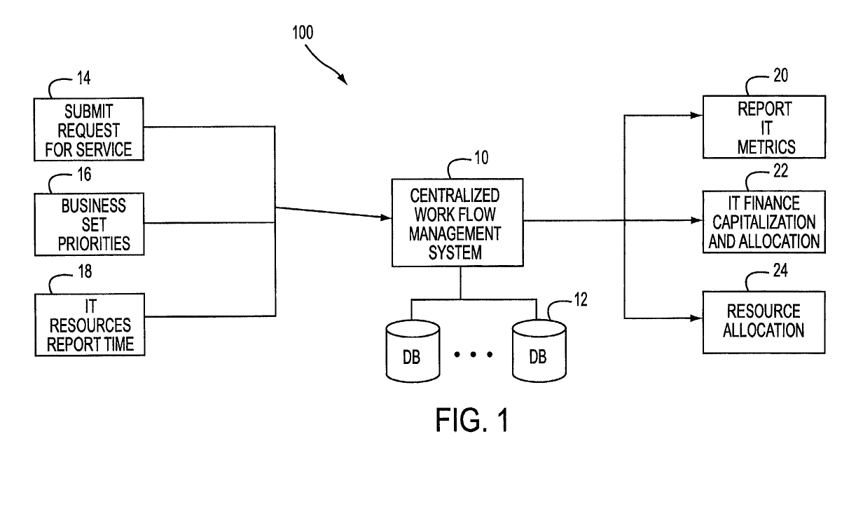

In particular, the system and process of the present invention relates to a method of using a centralized work flow management system for managing the flow of information and request for services within a large organization. One embodiment may be shown as a functional block diagram in FIG. 1. As shown in FIG. 1, a process 100 may involve the flow of information through a centralized work flow management system 10 and its associated data repositories 12. The following information may flow through centralized work flow management system 10: request submissions for services 14, business priorities set by various participants in the organization in 16, and IT resource reports and time entries 18. The following information may be provided from centralized work flow management system 10: reports on IT metrics 20, IT finance capitalization and allocation information 22, and resource allocation information 24. As demonstrated, through the use of the present invention, managers of the organization are better able to understand where information technology resources are being utilized, understand the necessary capitalization and allocation resources necessary to maintain those services, and generally maximize the efficiency of the organization and in particular, the information technology services provided to that organization.

According to one implementation of the present invention, the work flow management system may be a network based interface system to enable users to access and receive information via the Internet, intranet, extranet, or other network based applications to provide an automated input and output system. To organize the manner in which users are able to access and receive information, various interface pages may be provided by the centralized system to enable ease of use of the system. In one embodiment, the pages may comprise HTML or XML-based pages presentable to a user over the network such that the user may interact with the system using an XML or HTML-enabled browser system.

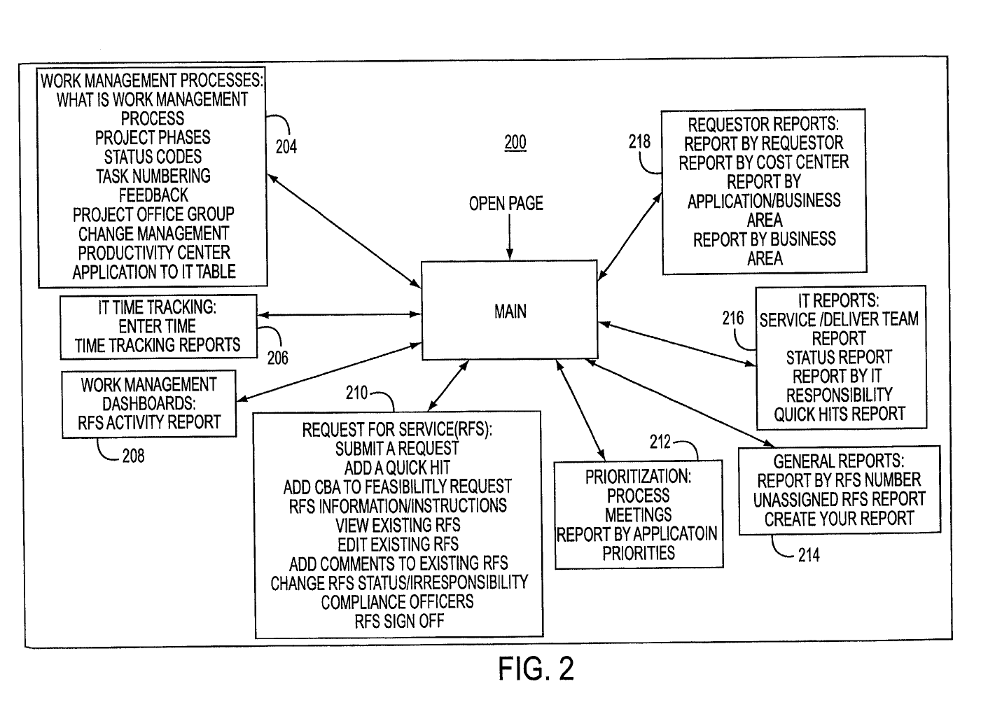

One embodiment of the organizational structure of the system is depicted in FIG. 2 where a flow diagram is presented. As shown, a user enters the system and receives a main interface page 202. From page 202, the user has a number of different options to be able to perform various classifications of tasks through the system. These tasks may fall within one or more of the following categories: work management processes 204, IT time tracking 206, work management dash boards 208, request for services 210, prioritization 212, general reports 214, IT reports 216, and requester reports 218. Each of the options available through those processes will be described in detail below.

Specifically, work management processes 204 may involve a number of screens that provide information and resources to work management participants of the system. In particular, the work management process interface 204 may enable a user to select to view information on the purpose and vision of the work management team, to view definitions and explanations about key processes and to view information about request for services and time tracking. Additionally, further screens may be provided to enable a user to see an overview of the process, understand project phases with status codes, review a list of status code definitions, understand the task numbering scheme, generate feedback through the selection of a single link to contact all members of the work management team, link to various pages within the organization, such as a project office group, change management group, and a productivity center, an application to information technology table, for example.

In addition, an IT time tracking functionality 206 may be provided to enable information technology service providers within the organization to enter time and generate time tracking reports for themselves, or enable managers to view time tracking reports for various members of the information technology team.

A work management dash board functionality 208 may also be provided that generates or a request for service activity report including the count of such requests by status, by type, by count of completed and canceled year to date, hours posted, cost estimates, and benefits all tallied in a single RFS activity report usable by members of the system.

In addition, a prioritization interface 212 may be provided with links to information about the standard prioritization process, links to documents that provide list of participants and prioritization meetings, and a link to a report that shows application priorities.

Through general reports module 214, a user may be presented with options to request a report by request for service number in which case an interface with a text box at the top to allow a user to enter a request for service number may be presented. A query may then be run to generate a report based on that request for service number. Additionally, a user may select a link to display a listing of all unassigned request for services. Through this link, the system presents a list of requests for service (e.g., all RFS's) for which no information technology personnel has yet been assigned. Additionally, through this interface, a user may select or create his or her own report.

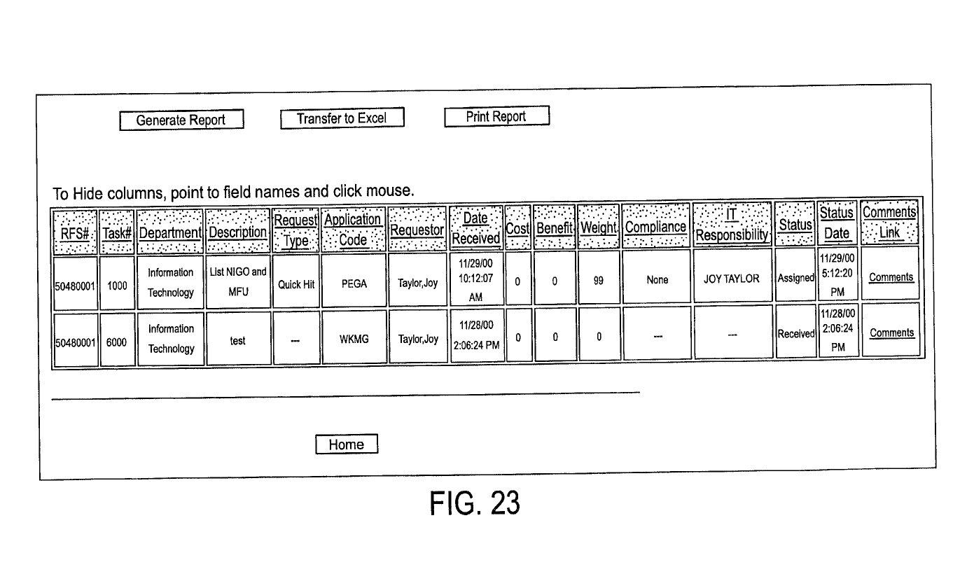

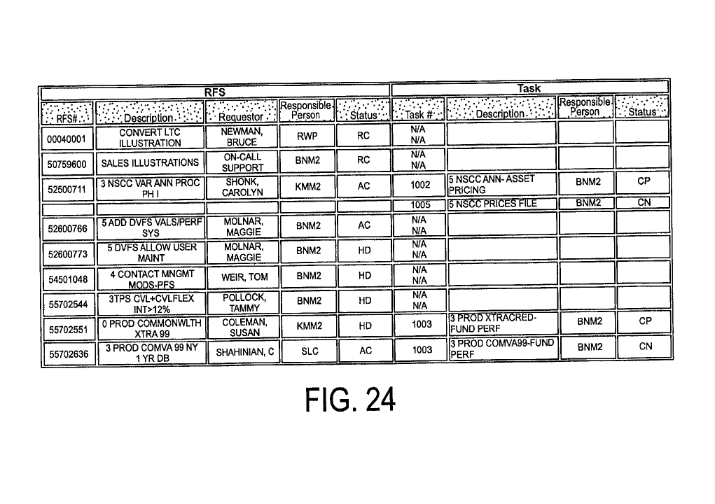

FIGS. 23 and 24 depict two different embodiments of report layouts that may be generated by the system of the present invention. As shown, different columns may be presented corresponding to fields within the database related to various requests for services. In the embodiment of FIG. 23, the user is presented with additional options to manipulate the report. For example, the user may generate a report, transfer the report to another program application such as Microsoft Excel or another spreadsheet program, or print the report through interface buttons as displayed in FIG. 23 for example. Additionally, the user may hide columns by pointing to a field name and clicking the mouse as shown in FIG. 23. Additionally, the user may rearrange the order in which entries or rows are presented by double clicking on the header field to use that field as the key to sort the results. According to one embodiment, initially reports may be sorted by a priority weight, but the user may choose other columns as the key for sorting, such as the request for service number, the request type, the requester, the day received, etc.

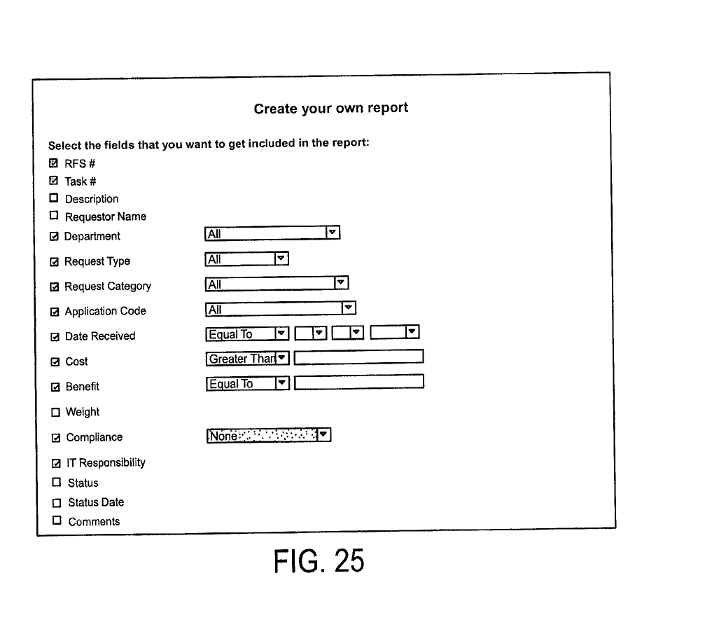

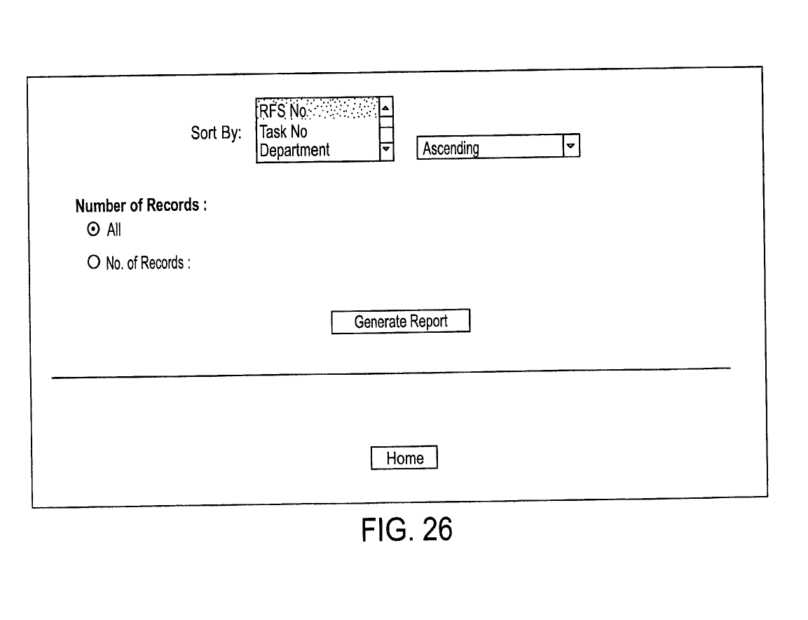

FIG. 25 depicts an embodiment of a user interface through which a user may create his own report upon entry of this interface from the report interface 214. As depicted, the user is presented with options to select the fields that they want to have provided in the report, including the fields for request for service number, task number, description, request or name, department (including the various departments), request type (including all of the various request types), application code (including all the application codes), date received, cost, benefit, weight, compliance, IT responsibility person, status, status due date, and comments fields. Upon selection of the various fields, the user may then submit the report request. The user may be presented with an interface as shown in FIG. 26. According to one embodiment, FIGS. 25 and 26 may be merged together into a single user interface, or may be spread across several user interfaces to ease in the user's entry of information. Once the user has selected the method and order by which to sort the rows of the report, the user may select a button to generate the report. Alternatively, a button such as a home button may be presented to enable the user to return to a previous interface.

Another interface presented through the main interface screen 202 is an IT report interface 216. For this interface, the user may engage in a number of activities through links to other interfaces or through the IT report interface itself. For example, the user may be able to select to receive reports about individual participants within the information technology team through a drop down box for example. Additionally, the user may be able to select to generate a report by information technology person responsibility. This page again may present a table driven drop down box to allow selection of the information technology responsibility for which the user wants to view data. Further, IT report interface 216 may enable a user to generate status reports. A status report request may also provide a table driven drop down box to allow selection of the status for which the user wishes to see data. Also, IT report interface 216 may enable a user to select to view a quick hits report which provides a table driven drop down box to allow selection of the site and request for service number for which the user wants to see data.

Through request a report interface 218, the user may be able to generate a report by requestor. In that report, the text box is presented to enable a requestor to enter his or her name. A query is then generated to gather all corresponding request for services and task data for that particular requestor. Also through user interface 218, a user may be able to request a report by cost center. In particular, if an organization has broken down its fmancial structure into a number of cost centers, this report will be helpful to managers to be able to determine which cost centers are generating the most reports. Thus, a requester or other user of the system may enter the site and cost center information into a drop down box and have a report generated showing all of the requests for services from that particular site and/or cost center. Also through requestor report module 218, a user may be able to request a report by application/business area. In this interface, a user is presented with a table driven drop down box to allow selection of the application and business area for which the user wants to see information. Additionally, a business area only drop down box may be presented through another user interface from requestor report interface 218.

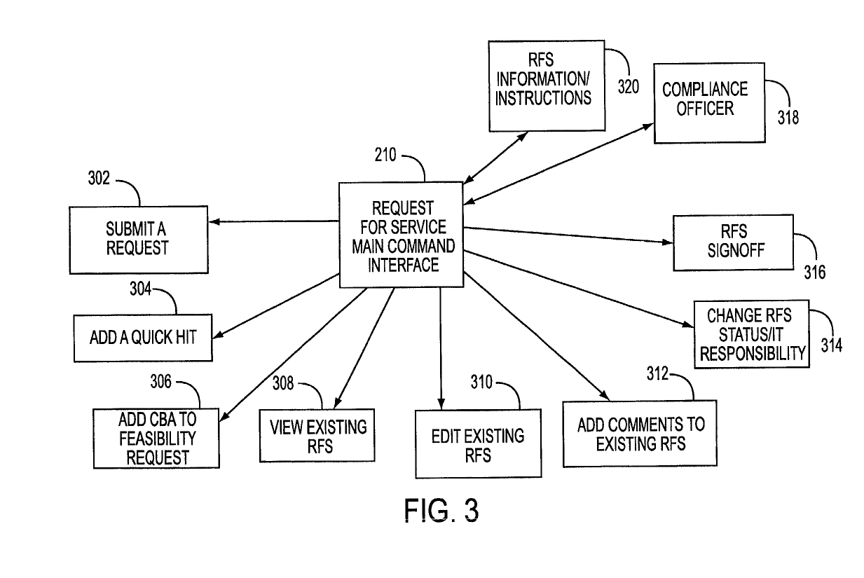

Main interface 202 also may provide a request for service interface 210 through which users of the system may initiate requests for service for information technology support. Through this interface, the user may engage in a number of activities related to requests for service as described below. An example of the various interfaces available from request for service interface 210 is depicted in FIG. 3. For example, a user may be able to link to different user interfaces for the following processes/tasks: submit a request 302, add a quick hit 304, add cost benefit analysis to a feasibility request 306, view an existing request for service 308, edit an existing request for service 310, add comments to an existing request for service 312, change a request for service status or IT responsibility 314, initiate a request for service sign off 316, enter screens or information for a compliance officer 318, and request for information instruction and information 320. The process and interface examples for some of these processes are described below.

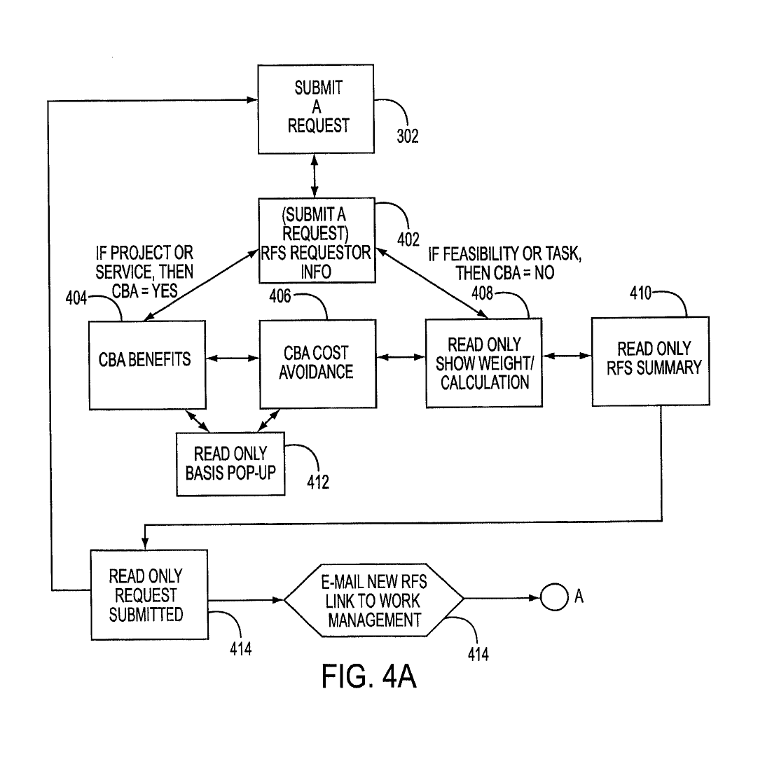

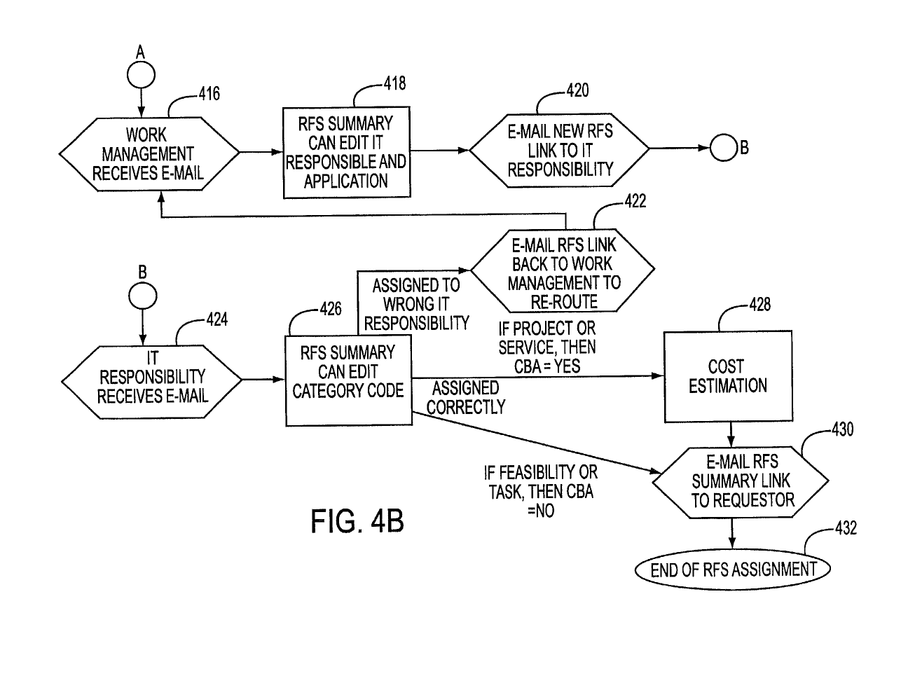

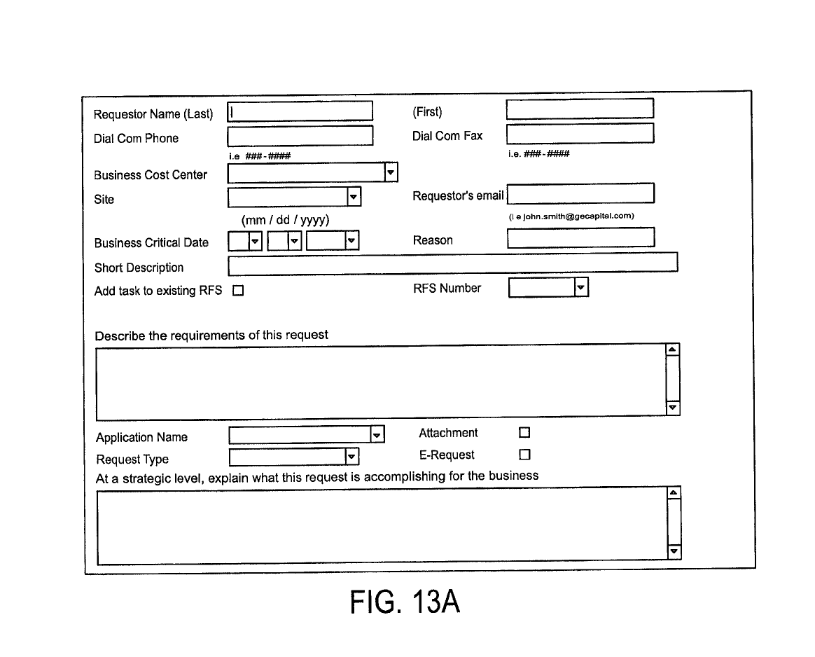

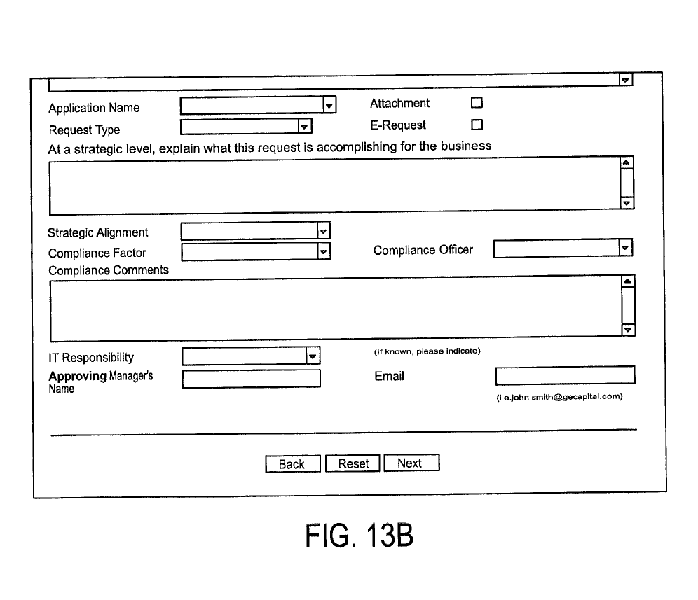

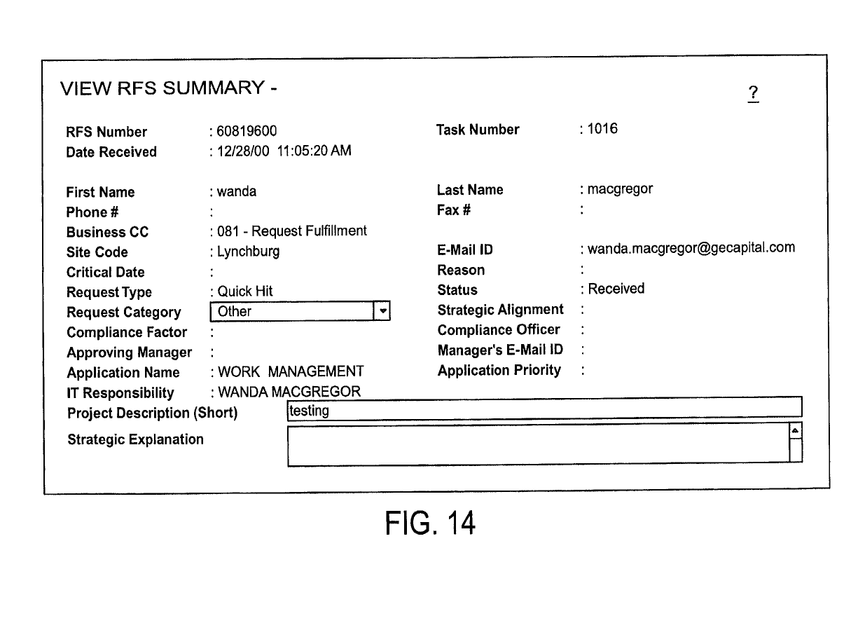

For example, FIGS. 4A-4B depict an embodiment of a flow diagram by which a user may submit a request for service through a user interface 302. In particular, when the user enters “submit a request” main interface 302, the user may be presented with options to submit a request with request for service requestor information in step 402. As part of step 402, the user is requested to indicate the type of request. In one embodiment, if the request is a new project or a service, then a cost benefit analysis may be requested in step 404. Through step 404, cost benefit analysis benefits are provided by the user and cost benefit analysis cost avoidance information may be presented in step 406. For both of these steps, a read only basis pop up interface may be presented that provides the basis upon which cost and benefits may be calculated. Additionally, once this information is submitted or if the request type is a feasibility or a task request, then a read only weight and calculation screen may be presented to indicate the priority of the request for service. Additionally, a request for service summary screen may be presented to the user. One embodiment of a request for service interface is depicted in FIGS. 13A-13B. As shown therein, the requestor may be requested to provide various types of information, including name, contact information, business cost center information, critical date, description, the ability to add just a task to an existing request for service, the application name and request type, strategic alignment (e.g., strategic initiative, customer, growth, competitiveness and foundation) and compliance factor information, compliance officer information, and IT responsibility information (if the requestor knows), and approving manager's name and email or other contact information (which may be automatically populated if the requestor has submitted a request before by storing the information in the database). When this information is provided and any cost benefit analysis information is added, the user may be presented with a summary of the request for service in step 410. As shown in FIG. 14, one example of such a summary is presented whereby the user has been presented with information for a request type of the type quick hit. The summary information enables the user to verify the information before submission in step 414. If the user decides that the information is not correct, they may cancel out and return to main submit a request screen 302/402.

If the request for service is submitted, then in step 414, that request for service may be electronically transmitted (e.g., via email) to a work management person assigned to receive new requests for service. In one embodiment, if the request type is a quick hit request, the work management person may initially determine whether the request truly fits that description. If the request is not appropriately classified, then the message may have a “deny” link that transmits a message back to the requester to inform the requestor that the request was improperly classified and that it should be resubmitted with a service request (which may involve additional approvals). To assist the user, the system may automatically change the request type to a service request that the user input cost benefits analysis information (as explained above for a service request). Next, in step 416, the manager receives the email and makes a determination regarding who the responsible information technology personnel should be and assigns that using the request for service summary in step 418. The manager may also select the application (e.g., computer program to be used or modified to complete the request). Additionally, in step 418, the manager may be able to edit other information in the request for service summary. Next, in step 420, a link to the request for service record in the database may be electronically transmitted (e.g., via email) to the information technology person responsible for that action as they have been assigned. In one embodiment, the system may be automated to transmit the link upon entry of a new or changed record in the database.

In step 424, the person with IT responsibility receives an email or other communication and in step 426 reviews the request for service summary. In step 426, the assigned IT responsible person may edit the category code or other information. Also, the IT person responsible reviews the summary to determine whether it has been properly assigned. If it has been assigned to the wrong information technology person, then in step 422 the information technology person may email the request for service link back to the work manager to be rerouted to the appropriate person. That reason may be workload or other reasons and the message from the IT person may include that understanding through text, check-boxes, etc.

If it was properly assigned and the request for service relates to projects or services, then a cost benefit analysis has been provided. Accordingly, in step 428, the information technology personnel responsible for the service reviews the cost benefits analysis information and may make a cost estimation for the project or service to be performed. The IT responsible person may be prompted to input an estimated number of hours for various categories of IT development and testing work for the request including: in-house work, domestic consulting work, on-shore consulting work, and off-shore consulting work. In addition, the IT person enters values for IT software assurance, IT operations, business area work (e.g., hours for test, materials and staff) and new equipment costs (e.g., workstations, servers, other hardware, software and other equipment).

After a cost estimation has been provided, in step 430, a request for service summary link may be sent back to the requestor indicating that it has been accepted and that information is available to review who the assigned information technology person is. If in step 426 the information technology person determines that the service is for a feasibility request or task request, then no cost benefit analysis is to be evaluated and step 430 is performed directly. In step 432, after the email link has been sent back to the request for service requestor, the assignment of the request for service is completed.

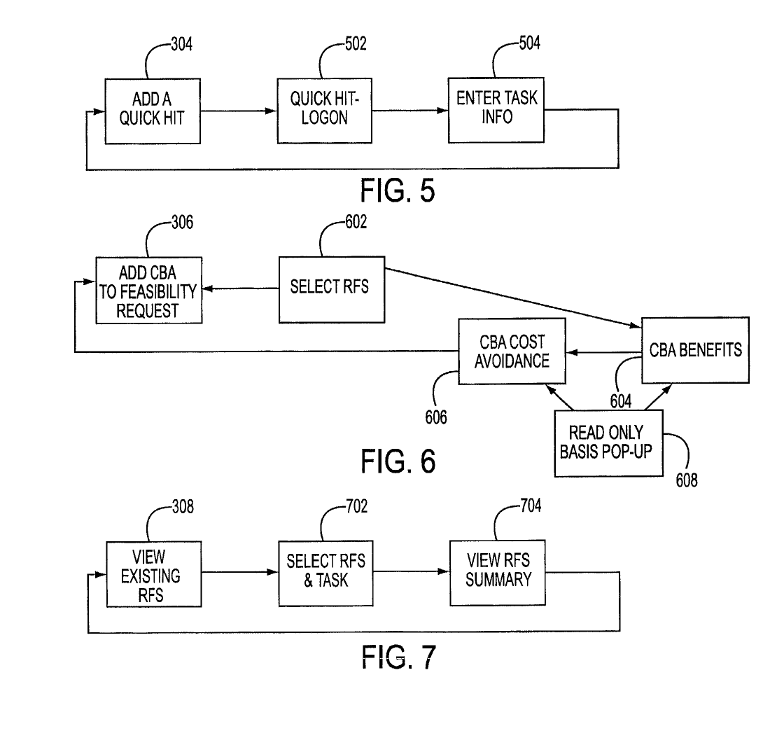

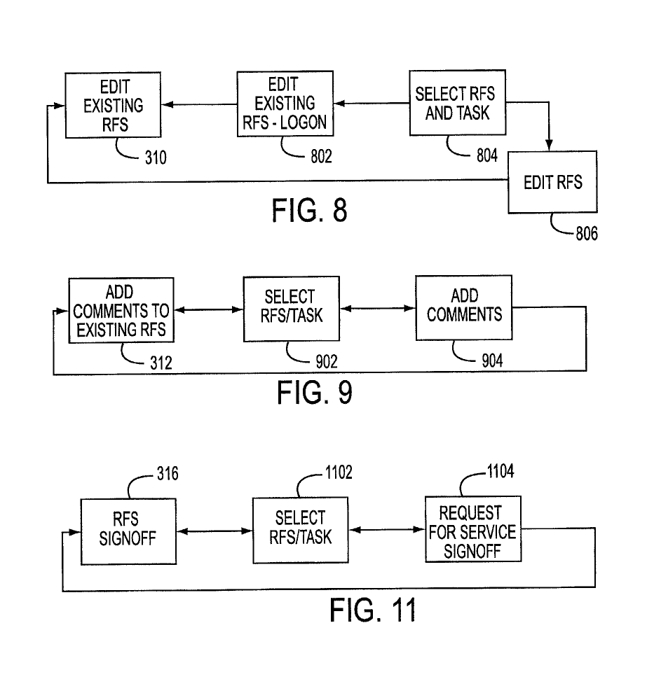

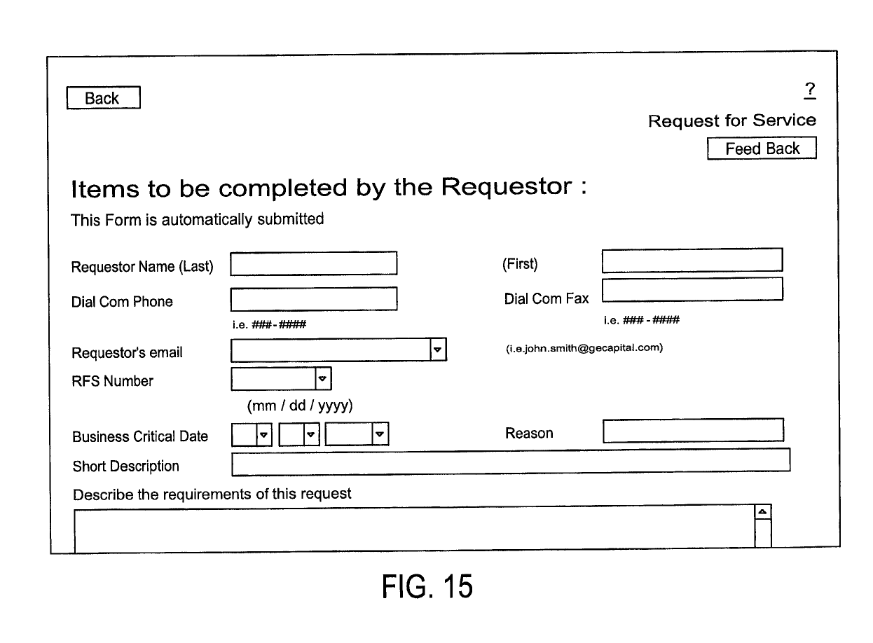

Another possible process accessible through interface 210 is to add a quick hit 304. According to one embodiment, as shown in FIG. 5, an “add a quick hit” interface 304 may be accessed which initiates a quick hit log on interface 502. Once the log on has been accepted, task information may be entered in step 504. In particular, a quick hit may be defined within the organization as a very small task (e.g., adding a new participant to a database or other miner task). An example user interface through which the user enters information for a quick hit is depicted in FIG. 15. This information includes contact information, a request for service number and a short description of the quick hit to be performed.

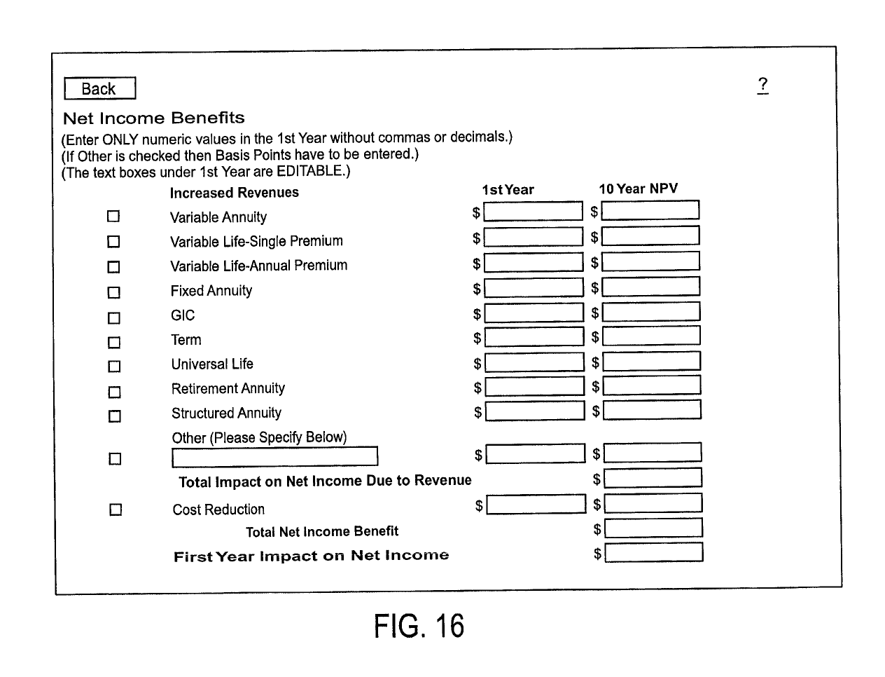

Although often feasibility requests do not involve a cost benefit analysis, a user may desire to add one as part of a feasibility request through interface 306. One embodiment of a process by which this may occur is depicted in FIG. 6. Specifically, upon entry of user interface 306, a user is requested to select a request for service in step 602 for which the cost benefit analysis is to be added. Once the particular RFS is selected, in step 604, cost benefit analysis input is received. In addition, a cost benefit analysis cost avoidance information may be input and in step 606 read only basis pop up interface 608 may also be provided. The interface is used for inputting cost benefit analysis may be similar to those used as previously discussed above. One example interface may be as shown in FIG. 16.

As shown in the example of FIG. 16, a user is presented with a number of products or services of the organization with check boxes in input information for income benefits. For example, as shown in FIG. 16, for an organization that provides financial services, various financial services may be listed with check boxes to the left. A user may then select which of the listed products or services will be benefited and to the right input the information to indicate the amount to be benefited in the first year and any 10 year net present value amount as well. Totals are then calculated to determine the total cost of net income benefit for the proposed feasibility request. A similar screen may also be presented to enable input of cost benefit analysis cost avoidance information. There the same information may be provided but in the right column the benefit indicates the cost savings as opposed to the increase in income.

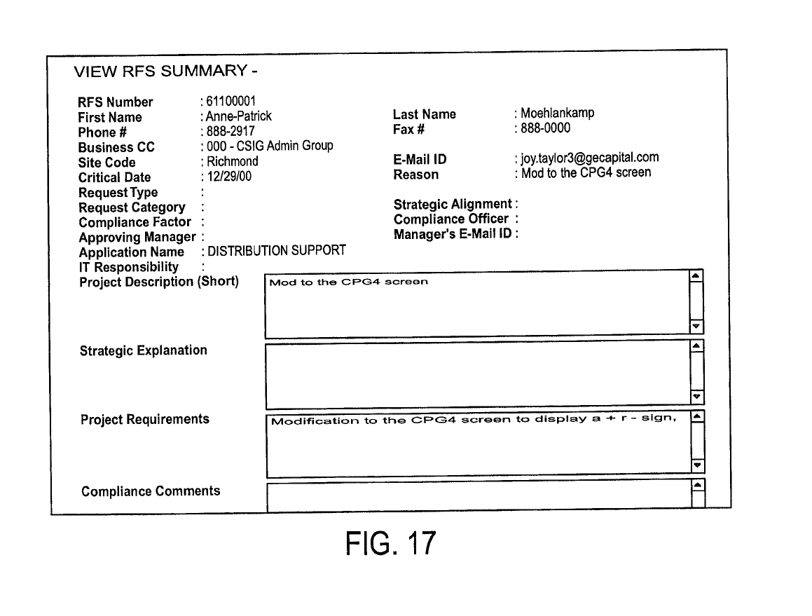

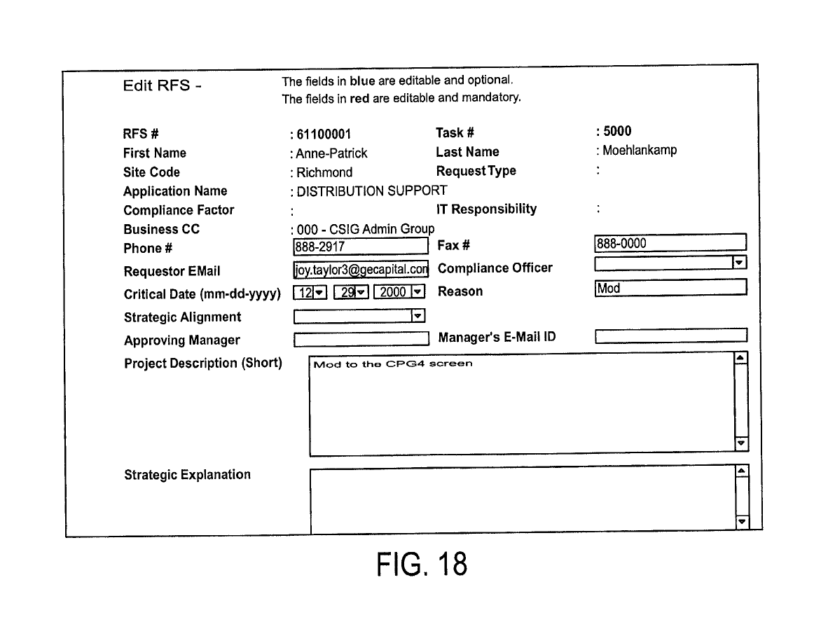

A user may also view an existing request for service through interface 308. An embodiment of the process by which this may occur is depicted in FIG. 7 by which an interface screen 702 asks for the user to select the request for service and the task information and then in step 704 presents the information in a summary analysis as for example depicted in FIG. 17. A user may then edit the existing request for service through interface 310 which may be accessed directly from the embodiment of FIG. 17 or through main interface 210. In particular, an edit existing request for service interface 310 may be presented to enable the user to log on in step 802, select a request for service in task in step 804 and then in step 806 edit the request for service through a user interface such as that depicted in FIG. 18.

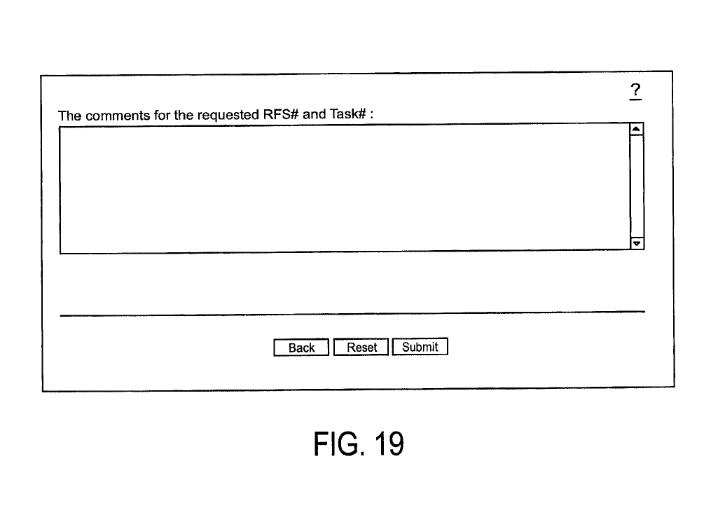

In addition, through interface 312, a user may be permitted to add comments to an existing request for service. An example of that process is depicted in FIG. 9 whereby upon entry of the add comments to existing request for service interface 312, a user is prompted to select a request for service and task in step 902 and then is presented with a comment entry field in which to add comments in step 904. An example of an interface through which the user may input this information is depicted in FIG. 19.

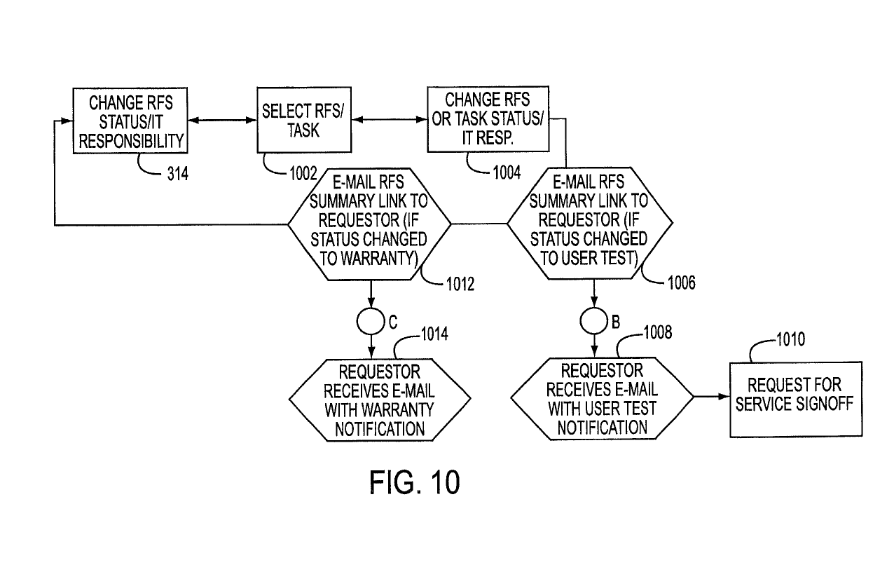

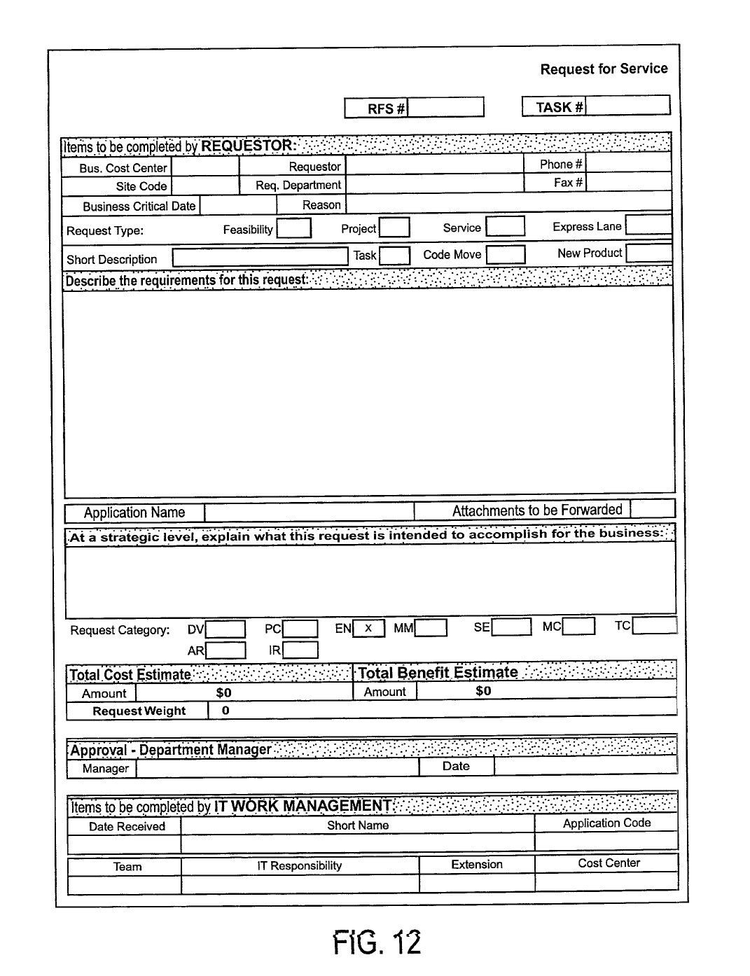

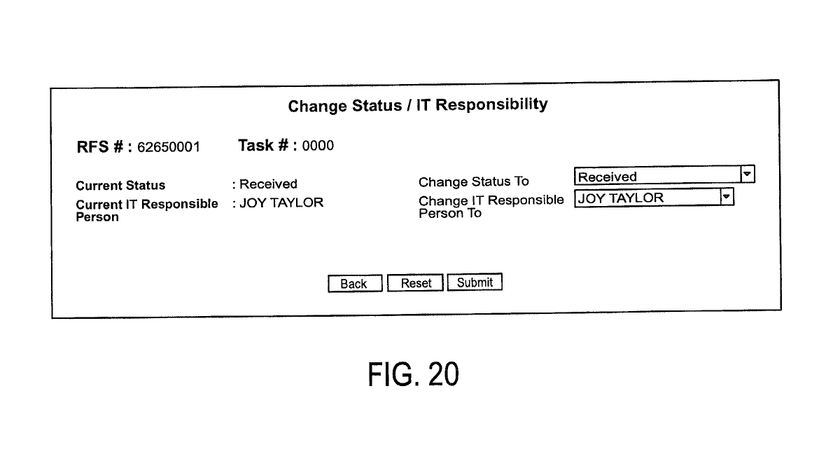

Various users of the system may also be authorized to change the status of a request for service or to change the information technology personnel responsible for a particular request for service through an interface 314. One embodiment of the process by which this may occur is depicted in FIG. 10. Specifically, upon entry of the interface the change of request for service status or information technology responsibility, the user is prompted to select the request for service and/or task in step 1002, and then change request for service or task status information in step 1004. An example interface through which the user may make these changes is depicted in FIG. 20. As shown in FIG. 20, the user may be presented with a drop down box to change status or to change the information technology responsible person. Additional navigational tools may also be provided to allow the user to return to previous screens, reset information or submit the changes. Upon change to a request for service, in step 1006, the system may email the request for service summary link to the original requestor, particularly if the status is changed to user test. In that case, the information technology personnel has indicated that the service has been provided to the extent that they are requesting the user to test the change or service being requested. In which case, in step 1008, the requestor receives the email with the user test notification in step 1008 and may proceed to request for service sign off in step 1010. Request for server sign off will be described below. In addition, if the status has been changed to warranty as determined in 1012, then in step 1014, the requestor receives an email with warranty information.

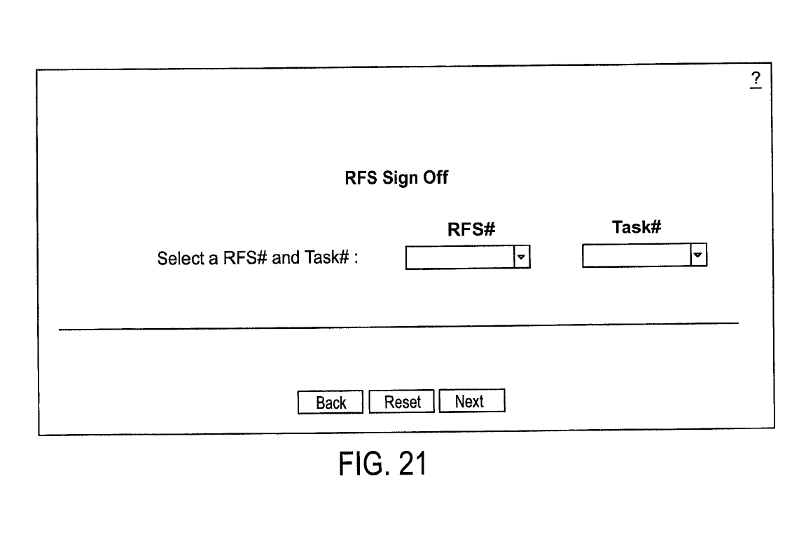

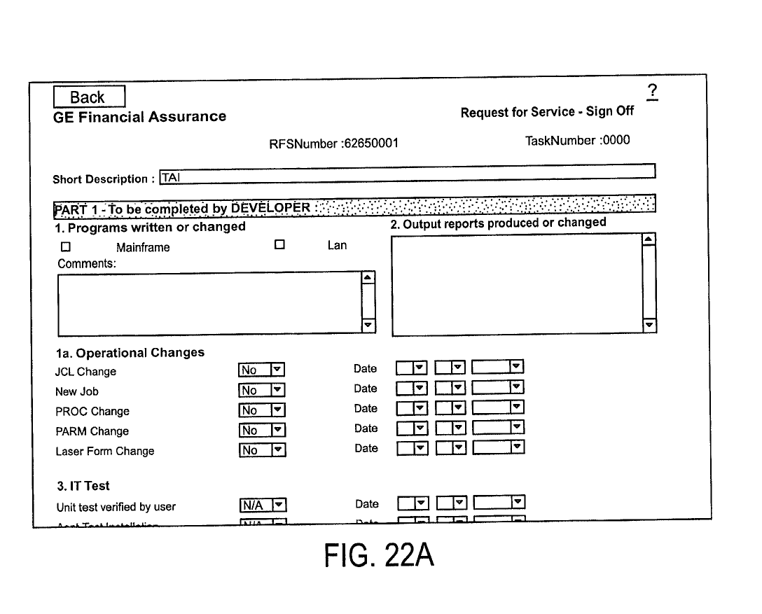

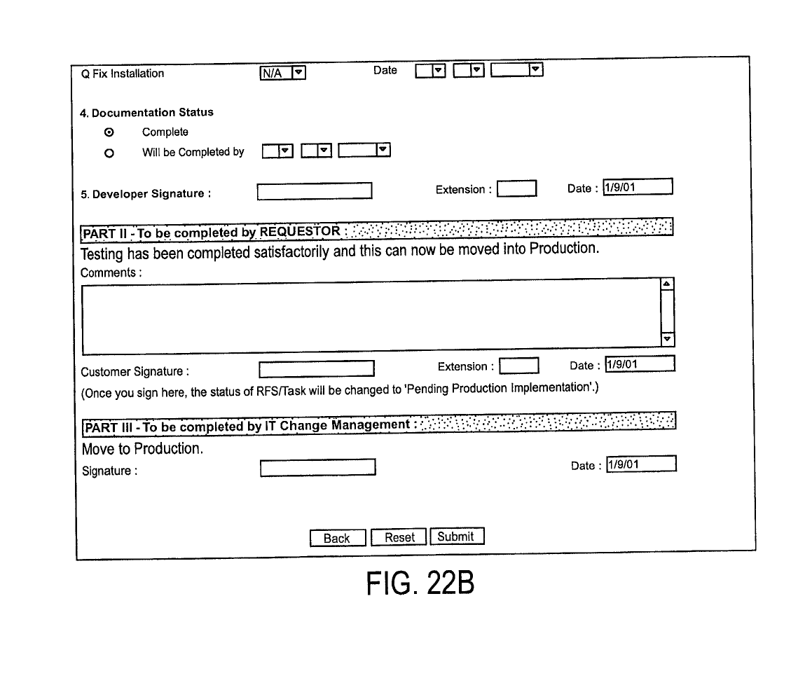

If a requestor has been provided a link to sign off on a request for service, the user may enter interface 316 to perform that task. One embodiment of the process for signing off on a request for service is depicted in FIG. 11. Upon entering the interface 316, the user selects the request for service and task in step 1102 and then initiates a sign off procedure in step 1104. One embodiment of a request for service sign off interface is depicted in FIG. 21. Specifically, a drop down menu is provided to enable the user to select a request for service number and/or task number if applicable. Upon selection, the user may be presented with interfaces as shown in FIGS. 22A-22B whereby the user provides detailed information about the operation. Additionally, this request for service sign off may be entered by an information technology person to fill out the first part which indicates various comments about the changes in work done on the particular request for service. As shown, the signoff interface may present inputs or information related to programs written or changed, output reports produced or changed, operational changes, IT tests performed, documentation status, and electronic signature for the developer or information technology personnel.

In interface 318, compliance officers may be able to access various information for those particular personnel. In interface 320, request for service information and instruction information may be presented to enable the user to understand the various interfaces, the meaning of various terms, the process, etc.

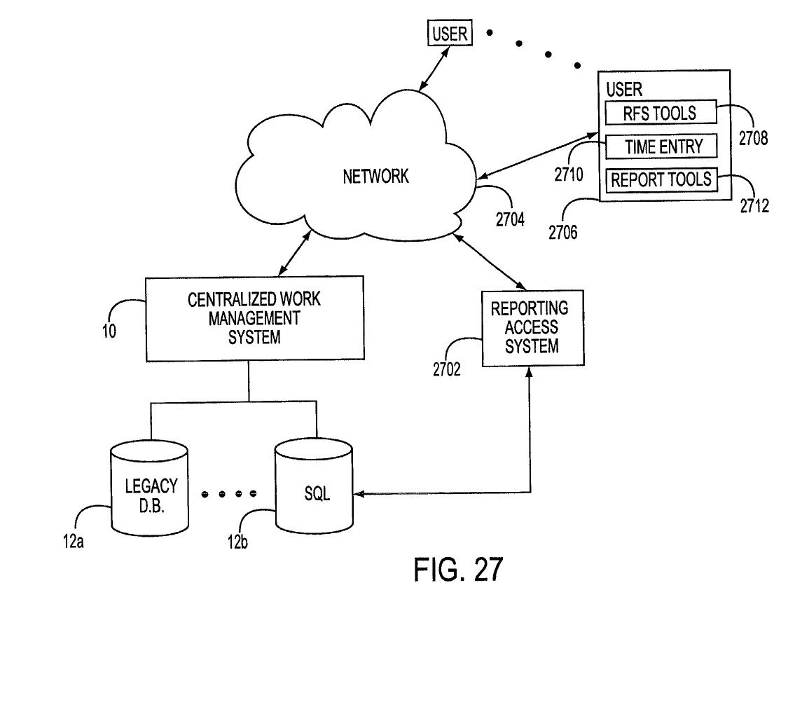

Although numerous different network architectures and systems may be utilized to implement the work flow management system of the present invention, one such embodiment is depicted in FIG. 27. Specifically, centralized work management system 10 including numerous database systems 12A-12B may connect over a network to various user systems 2706. Database systems may comprise a variety of legacy database systems (e.g., databases that maintained information technology request information from the past) as well as a SQL or other relational database access type system. According to a preferred embodiment, information input and request for service is stored in a SQL or other relational database system. By using such a system, report access system 2702 may interface directly with the relational database system or via centralized work management system 10 over the network to enable users to request and generate reports. User interface systems may provide functionality to enable request for submissions, time entry and various other reporting tools as depicted in FIG. 27. Request for service tools 2708, time entry 2710, and report tools 2712 may reside on user systems or may be web enabled tools residing on centralized work management system 10 or other network enabling tools that enable the user to run such information from the user system remotely. The network utilized may compromise an intranet, extranet, the Internet, LAN, WAN, or any other network. According to a preferred embodiment for use as an inner organizational system, an intranet may be utilized to limit access to such information by outsiders. According to one embodiment of the present invention, information may be stored in a legacy database system but extracted into a relational database system on a regular basis (e.g., daily).

According to one embodiment of the present invention, an automatic request for service number calculation system may be provided. According to one protocol, the number may compromise an eight digit format as follows: SCCCXXXX. The S corresponds to a one digit site code determined in the request or information interface. The 3 C's correspond to the three digit business cost center determined in the request for service request or information interface. And the 4 X's may represent the next sequential number in the series for the first four numbers in the request for service number using the relational database as a source of that information.

Service and project request may be given a priority weight based upon information as provided in the cost benefit analysis using known techniques and systems. One embodiment of such a system may be as disclosed in related application U.S. patent application Ser. No. 09/671,735 titled “Process for Alignment of Request for Information Technology Services.”

According to one embodiment of the present invention, the following status codes may be utilized: RC—received/inactive; AS—assigned to an IT responsibility person; AC—active/someone in progress coding; MI—pending model implementation; PI—pending implementation; UT—user testing; WP—warranty period; CP—completed; HD—on hold; and CN—canceled. In addition, various report request types may be defined as well. The following report request types may be utilized: DV—development (research, evaluation, design, coding, and testing of a new function that is completely independent of any system, module, etc., currently in existence); PC—platform consolidation (activities focused on merging or deleting a platform as a result of acquisitions, consolidations, or replacement of applications); EN—enhancement (changes that improve the efficiency or value of software); MM—mandatory maintenance (additional functions to existing software mandated by management directive or regulatory requirements including changes as a result of legislative, regulatory or tax requirements); SE—software error (existing code does not work according to specification, including incorrect screen displays, calculations, reports, documents, etc.); MC—minor change (any development, enhancement, maintenance, or software error request that is determined to require a certain number of hours or less to complete all tasks necessary to modify and install into a production environment including table changes, request and the like); AR—ad hoc reporting (request for reports, whether one time or symmetrically generated); and IR—incident report (system or application is down due to abnormal ending and requires developer intervention to resolve and permit continued processing or system availability, including batch processing job down or online application is unavailable because of an error).

Other embodiments and uses of the invention will be apparent to those skilled in the art from consideration of the specification and practice of the invention disclosed herein. The specification and examples should be considered exemplary only.

What is claimed is:

1. A system for managing the workflow of request for services from a department within an organization, the requests for service being provided by other members of the organization, the system comprising:
a request for service input module for enabling one or more requesting members of the organization to input information for a request for service from the department by connecting to the system over a network;
a database system for storing information regarding the requests for service received by the request for service input module;
a change of status input module for enabling a service provider participant from the department to update the status of a request by connecting to the system over a network; and
a signoff module to enable a service provider participant and a requesting member to signoff a requested service, the participant and requesting member connecting to the system over a network.

2. The system of claim 1 wherein the network comprises an intranet.

3. The system of claim 1 wherein the request for service module enables a user to change a pending request for service.

4. The system of claim 1 wherein the request for service module enables a user to input cost benefit analysis information related to the request for service.

5. The system of claim 1 further comprising a reporting module that enables users to request reports regarding requests for service stored in the database.

6. The system of claim 5 wherein the reporting module enables a user to request a report comprise reports regarding the activities of information technology personnel.

7. The system of claim 5 wherein the reporting module enables a user to request a report based on various parameters of the request for service.

8. The system of claim 1 further comprising a time entry module that enables service provider department participants to enter time regarding requests for service being processed.

9. The system of claim 8 further comprising a reporting module that enables a user to request a report regarding the time activities of one or more service provider department participants.

10. The system of claim 1 further comprising an electronic messaging module that generates a message regarding a request for service, the message including at least one link to the stored request for service.

11. The system of claim 10 wherein the electronic messaging module transmits a message regarding the receipt of a new request for service received by the request for service input module to a service provider department member.

12. The system of claim 11 wherein the electronic messaging module transmits a message regarding the receipt of a change to a request for service to the member that requested the service.

13. The system of claim 10 wherein the electronic messaging module transmits a message regarding availability of a service for user testing to the requestor of the service.

14. The system of claim 10 wherein the electronic messaging module transmits a message regarding the availability of a service for warranty review of a service to the requestor of the service.

15. A method for managing the workflow of request for services from a department within an organization, the requests for service being provided by other members of the organization, the method comprising the steps of:
enabling one or more requesting members of the organization to input information for a request for service from the department by connecting through a networked interface system;
storing information regarding the requests for service received;
electronically forwarding information regarding the received request for service to a service provider participant;
enabling a service provider participant to signoff a requested service based on performance of one or more tasks in the requested service; and
enabling a requester to signoff a requested service.

16. The method of claim 15 further comprising the step of assigning a received service to one or more service provider participants.

17. The method of claim 15 further comprising the step of enabling a service provider participant to change the status of a request for service through the networked system.

18. The method of claim 15 further comprising the step of presenting a requestor with an interface through which the user may input cost benefit analysis information related to the request for service.

19. The method of claim 15 further comprising the step of presenting a user with a reporting interface through which the user may request one or more reports regarding requests for service stored in the database.

20. The method of claim 15 wherein the one or more reports comprise one or more reports regarding the activities of information technology personnel.

21. The method of claim 15 further comprising the step of presenting a service provider participant with a time entry interface through which time may be entered and stored in a database relative to one or more requests for service.

22. The method of claim 15 further comprising the step of generating a message regarding a request for transmitting links to the stored request for service.

23. The method of claim 15 further comprising the step of transmitting a message regarding the receipt of a new request for service received by the request for service input module to a service provider department member.

24. The method of claim 15 further comprising the step of transmitting a message regarding the receipt of a change to a request for service to the member that requested the service.

25. The method of claim 15 further comprising the step of transmitting a message regarding availability of a service for user testing to the requester of the service.

26. The method of claim 15 further comprising the step of transmitting a message regarding the availability of a service for warranty review of a service to the requestor of the service.
